(19) United States
(12) Patent Application Publication
(10) Pub. No.: US 2012/0115976 A1
(43) Pub. Date: May 10, 2012

(54) UV-CURABLE OPTICAL RESIN ADHESIVE COMPOSITION

(75) Inventors: Kazumasa Igarashi, Ibaraki-shi (JP); Yuki Hasegawa, Ibaraki-shi (JP)

(73) Assignee: NITTO DENKO CORPORATION, Osaka (JP)

(21) Appl. No.: 13/289,491

(22) Filed: Nov. 4, 2011

(30) Foreign Application Priority Data
Nov. 8, 2010 (JP) 2010-249811
Feb. 10, 2011 (JP) 2011-027912

(51) Int. Cl. C09J 4/06; C09J 133/00; C08J 3/28

(52) U.S. Cl. 522/120; 522/153; 522/154

(57) ABSTRACT

A UV-curable optical resin adhesive composition is provided, which is excellent in transparency, adhesive reliability and durability and suitable for rework (repair) without an adverse influence on the brightness, the contrast and the Quality of a display image. The UV-curable optical resin adhesive composition is used for filling a gap between an image display panel and a protective cover plate, and comprises: (A) an acryl polymer having a (meth)acryloyl group at its side chain; and (B) a photopolymerization initiator.

### BACKGROUND OF THE INVENTION

1. Field of the Invention

The present invention relates to a UV-curable optical resin adhesive composition which is used for filling a gap between an image display panel and a protective cover plate stacked on the image display panel in a display structure, and is excellent in transparency, adhesion reliability and durability to ensure higher quality of a display image in terms of brightness and contrast, and suitable for rework (repair). 2. Description of the Related Art

With the recent advancement of the highly information-oriented society, various types of functional devices have been proposed, which include electronic display devices such as organic EL display devices, liquid crystal display devices, other image display panels and electrophoretic display devices, optical devices such as organic EL illumination devices, optical elements and optical waveguides, and solar cells such as thin film silicon solar cells, organic thin film solar cells and dye-sensitized solar cells.

Particularly, the liquid crystal display devices tend to be increased in scale and screen size in recent years, and are employed as larger size HDTVs and 3D TVs. Conventionally, such a liquid crystal display device includes a liquid crystal display panel (LCD module) and a protective cover plate (or a front cover formed of glass, an acryl resin or the like), and has an air gap structure (hollow structure) in which a gap of about 0.5 to about 1.5 mm was defined between the liquid crystal display panel and the protective cover plate for protection of a surface of the liquid crystal display panel and a polarization plate (see, for example, JP-A-2009-8851). However, the liquid crystal display panel (LCD module) with the polarization plate and the protective cover plate (front cover) each have a refractive index of about 1.5 with respect to the refractive index of air in the air gap structure, so that image light emitted from the LCD module is liable to diffuse or scatter in the panel and generally suffer from reduction in brightness and contrast due to reflection of external light such as sunlight. Thus, the liquid crystal display device often fails to provide a satisfactory image quality and, therefore, is required to display a higher quality image.

To cope with this, it is proposed to fill the air gap structure with a transparent optical resin having a refractive index closer to the refractive index of the glass or the acryl resin (see, for example, JP-A-2008-281997). By thus filling the air gap with the optical resin, an optical interface between the liquid crystal display panel (LCD module) and the protective cover plate (front cover) is eliminated to suppress the reflection and the scattering of the image light. This improves the brightness and the contrast, thereby providing a higher quality image. Further, the strength of the overall liquid crystal display device is increased by filling the air gap with the optical resin. Even if the protective cover plate (front cover) is broken, glass pieces of the protective cover plate are not scattered. At the same time, the strength of the liquid crystal display device can be improved.

When an image display device including a liquid crystal display panel, a touch panel plate provided on the liquid crystal display panel, a protective cover plate and a lens plate is assembled, these plates are bonded together. If the plates are improperly positioned with respect to each other to be bonded together, the resulting image display device should be discarded as a defective product, leading to a significant economic loss. Particularly, a larger-scale image display device is highly expensive and, therefore, it is necessary to increase the production yield and to repair the defective product. If the image display device is defective after the assembling and needs repair, an adhesive layer formed from the optical resin adhesive composition between the liquid crystal display panel (LCD module) and the protective cover plate (front cover formed of glass, an acryl resin or the like) is transversely cut along a center plane of the adhesive layer by means of a very fine wire, and a cured resin residue is swelled and removed with a solvent. Then, the resulting liquid crystal display panel and the protective cover plate are transferred again to the assembling step for rework (repair).

Meanwhile, a UV-curable optical resin adhesive composition comprising a polymer having a polyurethane acrylate main chain, a polymer having a polyisoprene acrylate main chain or a polymer having a polybutadiene acrylate main chain and a (meth)acrylate monomer has been proposed as the optical resin adhesive composition. In this case, a linear hydrocarbon solvent such as hexane or heptane or an aromatic hydrocarbon solvent such as toluene or xylene having a closer SP value (dissolution parameter) is preferentially used for swelling and removing the resin residue remaining after the adhesive layer is cut by means of the very fine wire to separate the liquid crystal display panel and the protective cover plate. However, the hydrocarbon solvents gradually infiltrate and swell a nonpolar cycloolefin polymer (COP) used as a material for a diffuser plate and a phase difference film of the polarization plate and the protective film, thereby disadvantageously damaging the polarization plate. Adhesive compositions comprising other polymers are also disadvantageous because a longer period of time is required for the swelling of the resin residue. That is, there is an eager demand for development of an optical resin adhesive composition which does not adversely affect the respective plate components of the image display device and permits easy repair (rework) by using a solvent for swelling the resin residue.

### SUMMARY OF THE INVENTION

In view of the foregoing, a UV-curable optical resin adhesive composition is provided which is excellent in transparency, adhesive reliability and durability and suitable for rework (repair) without an adverse influence on the brightness, the contrast and the quality of a display image.

There is provided a UV-curable optical resin adhesive composition for filling a gap between an image display panel and a protective cover plate, the UV-curable optical resin adhesive composition comprising:

(A) an acryl polymer having a (meth)acryloyi group at its side chain; and

(B) a photopolymerization initiator.

The optical resin composition comprising the acryl polymer (A) having the (meth)acryloyi group at its side chain and the photopolymerization initiator (B) ensures easy swelling and removal of a cured resin residue with the use of a solvent, and is excellent in transparency and adhesive reliability and suitable for rework (repair).

Where the acryl polymer (A) having the (meth)acryloyl group at its side chain is used, there is no need to use a polyfunctional (meth)acrylate as a reactive diluent, because the acryl polymer (A) has three-dimensional crosslinking points at its side chains unlike a typical urethane acrylate polymer prepared as having three-dimensional crosslinking points at its terminals by incorporating a (meth)acrylate in terminals of a polyurethane prepared through a reaction of a polyol and an isocyanate. In the case of the adhesive composition employing the typical urethane acrylate and the multifunctional (meth)acrylate, there is an adverse effect that the swelling property is significantly reduced due to an excessively high crosslinking density and the curing shrinkage is significantly increased. However, the acryl polymer (A) having the (meth)acryloyl group at its side chain is free from the adverse effect and, therefore, is industrially advantageous.

As described above, the UV-curable optical resin adhesive composition comprises the acrylate polymer (A) having the (meth)acryloyl group at its side chain and the photopolymerization initiator (B). Therefore, the UV-curable optical resin adhesive composition is excellent in transparency, adhesiveness and reworking (repairing) efficiency. Therefore, the UV-curable optical resin adhesive composition is very useful as a gap-filling material for filling a gap between an image display panel and a protective cover plate of an organic EL display device, a liquid crystal display device or the like.

Where the acryl polymer (A) is an acryl polymer having a (meth)acryloyl group and a hydroxyl group at its side chain, the UV-curable optical resin adhesive composition is excellent in transparency and reworking (repairing) efficiency and more excellent in adhesive reliability.

Where the acryl polymer (A) has a weight average molecular weight of 1000 to 20000, the UV-curable optical resin adhesive composition is improved in coatability, and further improved in strength, adhesiveness, weather resistance, solvent resistance and chemical resistance.

Where the inventive UV-curable optical resin adhesive composition further comprises a monofunctional (meth)acrylate compound as a reactive diluent, the UV-curable optical resin adhesive composition is improved in coatability with a reduced viscosity, and has improved adhesiveness in a cured state.

### DETAILED DESCRIPTION OF THE INVENTION

An embodiment will hereinafter be described in detail. However, it should be understood that the invention be not limited to this embodiment.

The UV-curable optical resin adhesive composition comprises:

(A) a specific acryl polymer; and
(B) a photopolymerization initiator.

The UV-curable optical resin adhesive composition is used for filling a gap between an image display panel and a protective cover plate (front cover). More specifically, the UV-curable optical resin adhesive composition is used as a gap-filling material for filling a gap of about 0.5 to about 1.5 mm of a hollow structure (air gap structure) between the image display panel and the protective cover plate (front cover) such as of glass or an acryl resin. In general, spacers are provided between the image display panel and the protective cover plate to define the hollow structure between the image display panel and the protective cover plate (front cover). The spacers may each have a linear shape or a spherical shape. The spacers may be fixed by an adhesive. In any case, the gap of about 0.5 to about 1.5 mm between the image display panel and the protective cover plate is filled with the spacers.

In the present specification, (meth)acryloyl means acryloyl or methacryloyl, and (meth)acrylate means acrylate or methacrylate. Further, (meth)acrylic acid means acrylic acid or methacrylic acid, and (meth)acryloxy means acryloxy or methacryloxy.

The specific acryl polymer (A) as an essential component is an acryl polymer having a (meth)acryloyl group at its side chain or an acryl polymer having a hydroxyl group in addition to the (meth)acryloyl group at its side chain, and is prepared, for example, through a reaction of a vinyl polymer having a hydroxyl group at its side chain and a (meth)acryloyl-containing isocyanate compound.

The vinyl polymer having the hydroxyl group at its side chain is a vinyl polymer prepared through a higher temperature continuous polymerization method by polymerizing a hydroxyl-containing vinyl monomer, a non-hydroxyl-containing vinyl monomer and other vinyl monomer. The vinyl polymer having the hydroxyl group at its side chain is preferably a liquid random copolymer having a weight average molecular weight of 500 to 20000, a hydroxyl equivalent (OHV) of about 5 to about 200 mg KOH/g. Specific examples of the vinyl polymer having the hydroxyl group at its side chain are vinyl polymers disclosed in JP-A-HEI7(1996)-101902 and JP-A-2001-348560.

Examples of the hydroxyl-containing vinyl monomer include hydroxyl-containing (meth)acrylates such as 2-hydroxyethyl (meth)acrylate, 4-hydroxybutyl (meth)acrylate, hydroxypropyl (meth)acrylate, pentaerythritol (meth)acrylate and glycerin (meth)acrylate, which may be used either alone or in combination. It is particularly preferred to use hydroxyethyl (meth)acrylate, because it ensures advantageous random copolymerization.

Examples of the non-hydroxyl-containing vinyl monomer include monofunctional (meth)acrylates such as methyl (meth)acrylate, ethyl (meth)acrylate, propyl (meth)acrylate, isopropyl (meth)acrylate, butyl (meth)acrylate, isobutyl (meth)acrylate, t-butyl (meth)acrylate, isooctyl (meth)acrylate, neopentyl (meth)acrylate, 2-ethylhexyl (meth)acrylate, isodecyl (meth)acrylate, lauryl (meth)acrylate, styryl (meth)acrylate, isobonyl (meth)acrylate, dicyclopentanyl (meth)acrylate, tricyclodecyl (meth)acrylate, tetrahydrofurfuryl (meth)acrylate, glycidyl (meth)acrylate, cyclohexyl (meth)acrylate, 2-methoxyethyl (meth)acrylate, dimethylaminoethyl (meth)acrylate, chloroethyl (meth)acrylate and trifluoroethyl (meth)acrylate, which may be used either alone or in combination. It is particularly preferred to use butyl (meth)acrylate, 2-ethylhexyl (meth)acrylate, lauryl (meth)acrylate or cyclohexyl (meth)acrylate, which has an ester residue having not less than one and not greater than 20 carbon atoms, because the resulting cured product satisfies requirements for the flexibility and the tack-free property.

Examples of the other vinyl monomer include crotonates, α-olefins, chloroethylenes, vinyl ethers, vinyl esters, isopropenyl ethers, allyl ethers, allyl esters, aromatic vinyl monomers and (meth)acrylic acid, which may be used either alone or in combination.

The proportions of the hydroxyl-containing vinyl monomer and the non-hydroxyl-containing vinyl monomer to be used for the polymerization reaction are properly determined so as to provide a liquid random copolymer having a hydroxyl equivalent (OHV) of about 5 to about 200 mg KOH/g attributable to the vinyl polymer having the hydroxyl group at its side chain. If the hydroxyl equivalent (OHV) is excessively small, the resulting UV-curable optical resin adhesive composition is liable to be insufficient in crosslinking density, strength, transparency, adhesiveness, solvent resistance and chemical resistance in a cured state. If the hydroxyl equivalent (OHV) is excessively great, the resulting UV-curable optical resin adhesive composition is liable to have a higher glass transition temperature (Tg) and a higher elastic modulus in a cured state, failing to exhibit sufficient adhesiveness.

The vinyl polymer having the hydroxyl group at its side chain is prepared from the aforementioned monomers through the continuous polymerization method at a higher temperature (e.g., 150° C. to 350° C.), and has a weight average molecular weight of 500 to 20000. Particularly, a liquid vinyl polymer having a weight average molecular weight of 1000 to 15000 is preferred for coatability, strength, adhesiveness, weather resistance, solvent resistance and chemical resistance. The weight average molecular weight is determined through measurement by gel permeation chromatography (GPC) based on styrene calibration standard.

On the other hand, examples of the (meth)acryloyl-containing isocyanate compound to be used include (meth)acryloxyisocyanate compounds such as 2-isocyanatoethyl methacrylate, 2-isocyanatoethyl acrylate and 1,1-bis(acryloxymethyl)ethyl isocyanate, which may be used either alone or in combination. It is particularly preferred to use 2-isocyanatoethyl methacrylate, because the resulting cured product satisfies requirements for the hardness and the tack-free property.

As described above, the specific acryl polymer (A) to be used is synthesized through a reaction of the vinyl polymer having the hydroxyl group at its side chain and the (meth)acryloyl-containing isocyanate compound. For the synthesis, the vinyl polymer having the hydroxyl group at its side chain and the (meth)acryloyl-containing isocyanate compound are allowed to react with each other in the presence of a catalyst of a metal such as titanium or tin or an organic metal salt such as dibutyl tin laurate in an inert gas atmosphere at a room temperature (at about 20° C.) or under heating up to 30° C. to 80° C. Thus, the acryl polymer having the (meth)acryloyl group at its side chain or having the hydroxyl group and the (meth)acryloyl group at its side chain is prepared, which is viscous at around a room temperature (25° C. ±15° C.).

The acryl polymer having the (meth)acryloyl group and the hydroxyl group at its side chain is prepared in the following manner. The (meth)acryloyl-containing isocyanate compound and the vinyl polymer having the hydroxyl group at its side chain are blended in amounts such that the number of isocyanate groups in the (meth)acryloyl-containing isocyanate compound is from 0.1 to 99.9 mol % with respect to the number of the hydroxyl groups in the vinyl polymer having the hydroxyl group at its side chain, and then allowed to react with each other. Thus, the acryl polymer having the (meth)acryloyl group and the hydroxyl group at its side chain is prepared. Further, the proportion of the (meth)acryloyl-containing isocyanate compound is preferably 10 to 90 mol %, particularly preferably 15 to 60 mol %.

The acryl polymer having the (meth)acryloyl group at its side chain or the acryl polymer having the (meth)acryloyl group and the hydroxyl group at its side chain as the specific acryl polymer (A) preferably has a weight average molecular weight of 1000 to 20000, particularly preferably 1500 to 5000. Since the specific acryl polymer (A) has a weight average molecular weight in the aforementioned range, the adhesive composition comprising the specific acryl polymer (A) advantageously has crosslinking points in its molecule and, in a cured state, is excellent in transparency, adhesive reliability and durability because of its higher crosslinking density, and has a lower curing shrinkage. Where the acryl polymer (A) has the (meth)acryloyl group and the hydroxyl group at its side chain, the adhesive reliability is advantageously further improved. The resulting cured product has an acryl main chain skeleton and, therefore, is excellent in weather resistance. In addition, it is possible to select a swelling solvent from various solvents that are noncorrosive to nonpolar cycloolefin polymers (COP) as materials for a diffuser plate, a phase difference film and a protective film for a polarization plate. The weight average molecular weight is determined through measurement by gel permeation chromatography (GPC) based on styrene calibration standard.

During the synthesis reaction of the specific acryl polymer (A), a modification degree is confirmed, for example, by measuring absorbance at a characteristic absorption band (at about 2260 cm⁻¹) attributable to the isocyanate group in an infrared absorption spectrum, because the absorbance at the characteristic absorption band attributable to the isocyanate group is reduced as the reaction proceeds. The completion of the modification in the synthesis reaction is determined based on the fact that the absorbance at the characteristic absorption band attributable to the isocyanate group is reduced to zero.

The photopolymerization initiator (B) to be used together with the specific acryl polymer (A) serves as an ultraviolet radiation (UV) curing agent, and may be a photoradical polymerization initiator, a photo-cation polymerization initiator or the like. Where the UV-curable optical resin adhesive composition is used for a touch panel including transparent electrodes such as of ITO (indium tin oxide) provided on a liquid crystal display device, the photoradical polymerization initiator is preferably used in order to prevent the corrosion of ITO which may otherwise occur due to ions (particularly counter anions) of the photopolymerization initiator.

Examples of the photoradical polymerization initiator include 2,2-dimethoxy-1,2-diphenylethan-1-one, 1-hydroxycyclohexyl phenyl ketone, 2-hydroxy-2-methyl-1-phenylpropan-1-one, 1-[4-(2-hydroxyethoxy)-phenyl]-2-hydroxy-2-methyl-1-propane, 2-hydroxy-1-{4-[4-(2-hydroxy-2-methylpropyonyl)benz yl]phenyl}-2-methylpropan-1-one, 2-benzyl-2-dimethylamino-1-(4-morpholinophenyl)buta none-1, 2-methyl-1-(4-methylthiophenyl)-2-morpholinopropan-1-one, bis(2,4,6-trimethylbenzoyl)phenylphosphine oxide, 2,4,6-trimethylbenzoyldiphenylphosphine oxide and bis(η5-2,4-cyclopentadien-1-yl)-bis(2,6-difluoro-3(1H-pyrrol-1-yl)phenyl) titanium, which may be used either alone or in combination. For higher curing rate and thicker film curability, 2,2-dimethoxy-1,2-diphenylethan-1-one, 1-hydroxycyclohexyl phenyl ketone and 2-hydroxy-1-{4-[4-(2-hydroxy-2-methylpropyonyl)benz yl]phenyl}-2-methylpropan-1-one are particularly preferred.

The proportion of the photopolymerization initiator is preferably 0.1 to 30 wt %, more preferably 0.5 to 20 wt %, based on the overall amount of the UV-curable optical resin adhesive composition. If the proportion of the photopolymerization initiator is excessively small, the polymerization degree tends to be insufficient. If the proportion of the photopolymerization initiator is excessively great, a greater amount of a decomposition residue remains, and the resulting UV-curable optical resin adhesive composition tends to be poorer in durability, solvent resistance and chemical resistance.

The UV-curable optical resin adhesive composition may further comprise monofunctional (meth)acrylate compound as a reactive diluent. Examples of the monofunctional (meth)acrylate compound include monofunctional (meth)acrylates such as methyl (meth)acrylate, ethyl (meth)acrylate, propyl (meth)acrylate, isopropyl (meth)acrylate, butyl (meth)acrylate, isobutyl (meth)acrylate, t-butyl (meth)acrylate, isooctyl (meth)acrylate, neopentyl (meth)acrylate, 2-ethylhexyl (meth)acrylate, isodecyl (meth)acrylate, lauryl (meth)acrylate, styryl (meth)acrylate, isobonyl (meth)acrylate, dicyclopentanyl (meth)acrylate, tricyclodecyl (meth)acrylate, tetrahydrofurfuryl (meth)acrylate, glycidyl (meth)acrylate, cyclohexyl (meth)acrylate, 2-methoxyethyl (meth)acrylate, dimethylaminoethyl (meth)acrylate, chloroethyl (meth)acrylate, trifluoroethyl (meth)acrylate, 2-hydroxyethyl (meth)acrylate, 4-hydroxybutyl (meth)acrylate, hydroxypropyl (meth)acrylate, pentaerythritol (meth)acrylate and glycerin (meth)acrylate, which may be used either alone or in combination. For improvement of the adhesiveness of the resulting cured product, it is particularly preferred to use tetrahydrofurfuryl (meth)acrylate or glycidyl (meth)acrylate whose ester residue is a cyclic ether, or 2-hydroxyethyl (meth)acrylate, 4-hydroxybutyl (meth)acrylate, hydroxypropyl (meth)acrylate, pentaerythritol (meth)acrylate or glycerin (meth)acrylate whose ester residue has a hydroxyl group. It is more preferred to use 2-hydroxyethyl (meth)acrylate or tetrahydrofurfuryl (meth)acrylate.

The proportion of the monofunctional (meth)acrylate compound as the reactive diluent is preferably 5 to 200 parts by weight, more preferably 10 to 100 parts by weight, based on 100 parts by weight of the acryl polymer (A) having the (meth)acryloyl group at its side chain. If the amount of the monofunctional (meth)acrylate compound to be added is excessively small, it is difficult to sufficiently improve the adhesiveness of the UV-curable optical resin adhesive composition. If the amount of the monofunctional (meth)acrylate compound to be added is excessively great, the resulting UV-curable optical resin adhesive composition tends to be poorer in coatability with a lower viscosity.

Particularly, if the image display device includes a glass plate (e.g., the protective cover plate (front cover) is formed of glass), it is effective to add a silane coupling agent to the UV-curable optical resin adhesive composition for improvement of the adhesiveness of the composition.

Examples of the silane coupling agent include 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropyltriethoxysilane, 3-acryloxypropyltrimethoxysilane, N-2-(aminoethyl)-3-aminopropylmethvldimethoxysilane, N-2-(aminoethyl)-3-aminopropyltrimethoxysilane, N-2-(aminoethyl)-3-aminopropyltriethoxvsilane, 3-aminopropyltrimethoxysilane, 3-triethoxysilyl-N-(1,3-dimethylbutylidene)propylamine, N-phenyl-3-aminopropyltriethoxysilane, a hydrochloride of N-(vinyibenzyl)-2-aminoethyl-3-aminopropyltrimethoxysilane, 3-ureidopropyltrimethoxysilane, 3-chloropropyltrimethoxysilane, 3-mercaptopropylmethyldimethoxysilane, 3-mercaptopropyitrimethoxysilane, bis(triethoxysilylpropyl)tetrasulfide and 3-isocyanatopropyltriethoxysilane, which may be used either alone or in combination. For longer duration of the adhesiveness of the composition to the glass, it is particularly preferred to use 3-methacryloxypropyltriethyoxysilane or 3-acryloxypropyltrimethoxysilane.

The amount of the silane coupling agent to be added is preferably 0.1 to 10 parts by weight, more preferably 0.5 to 5 parts by weight, based on a total amount of 100 parts by weight of the acryl polymer (A) having the (meth)acryloyl group at its side chain and the monofunctional (meth)acrylate compound as the reactive diluent. If the amount of the silane coupling agent to be added is excessively small, it is difficult to sufficiently improve the adhesiveness of the UV-curable optical resin adhesive composition. If the amount of the silane coupling agent to be added is excessively great, the resulting UV-curable optical resin adhesive composition tends to be poorer in coatability with a lower viscosity.

In addition to the aforementioned components, additives such as an antioxidant, a defoaming agent, a surface active agent, a colorant, an organic filler, spacers, a tackiness/adhesiveness imparting agent may be optionally blended in the UV-curable optical resin adhesive composition as required. These additives may be used either alone or in combination.

The UV-curable optical resin adhesive composition can be prepared, for example, by blending the specific acryl polymer (A), the photopolymerization initiator (B) and other additives, and mixing and kneading the resulting mixture with stirring by means of a planetary stirring mixer of a rotation/revolution type or a glass stirring container.

The UV-curable optical resin adhesive composition thus prepared is cured, for example, by irradiation with ultraviolet radiation by means of a UV lamp. After the irradiation with the ultraviolet radiation, as required, the UV-curable optical resin adhesive composition is post-cured at a predetermined temperature to fill the gap between the image display panel and the protective cover plate.

Various known light sources are usable for the irradiation with the ultraviolet radiation, and examples of the light sources include a carbon arc lamp, a mercury vapor arc lamp, an ultrahigh pressure mercury lamp, a high pressure mercury lamp and a xenon lamp, which are capable of effectively emitting ultraviolet radiation.

Where a liquid crystal display device is assembled with the use of the UV-curable optical resin adhesive composition, the assembling can be achieved through an assembling process, which includes the steps of preparing a commercially available LCD panel, a commercially available protective cover plate (glass plate or the like) and a touch panel bonding machine, loading the protective cover plate and the LCD panel into the touch panel bonding machine, applying the adhesive composition on at least one of the protective cover plate and the LCD panel, bonding the protective cover plate and the LCD panel in vacuum, temporarily curing the adhesive composition by irradiation with ultraviolet radiation, permanently curing the adhesive composition by irradiation with ultraviolet radiation, and unloading the resulting product. Particularly, the UV-curable optical resin adhesive composition is advantageous for an assembling process employing a production apparatus having an auto-alignment function.

If inconvenience occurs in the liquid crystal display device after the assembling of the liquid crystal display device, an adhesive layer formed between the LCD panel and the protective cover plate is cut by the very fine wire to separate the panel and the plate from each other, and a resin residue remaining on surfaces of the separated panel and plate is swelled and removed by a solvent. In general, a repair solvent (swelling solvent) is soaked in a nonwoven fabric wiper, which is in turn placed on the resin residue to swell the resin residue. Examples of the swelling solvent include ketones such as methyl isobutyl ketone (MIBK), esters, ethers and cellosolves that are non-corrosive to nonpolar cycloolefin polymers (COP). After the resin residue is removed, the panel and the plate are cleaned with an alcohol solvent, and transferred again to the assembling process.

The cure degree of the UV-curable optical resin adhesive composition can be controlled by the dose (cumulative dose) of the ultraviolet radiation for the irradiation. If a relationship between the cumulative dose and the wire cutting strength is preliminarily determined, the wire cutting strength can be set as desired for proper reworking (repairing) efficiency. It is possible to estimate conditions for the curing of the UV-curable optical resin adhesive composition by plotting a relationship between the cumulative exothermic heat amount and the cumulative dose of the ultraviolet radiation which provides a desired characteristic value. For stabilization of the physical properties of the UV-curable optical resin adhesive composition, it is preferred to select UV irradiation conditions which provide a cumulative dose equivalent to not less than 90% of the cumulative exothermic heat amount.

In the liquid crystal display device, for example, the gap between the liquid crystal display panel and the protective cover plate can be filled with the UV-curable optical resin adhesive composition. More specifically, as described above, the UV-curable optical resin adhesive composition is used as a gap-filling material for filling the gap of about 0.5 to about 1.5 mm between the liquid crystal display panel (exemplary image display panel) and the protective cover plate.

### EXAMPLES

Next, inventive examples will be described in conjunction with comparative examples. However, it should be understood that the invention be not limited to these inventive examples.

### Example 1

First, 40 g (0.0784 mol OH group) of a liquid acryl polymer (hydroxyl-containing vinyl polymer) having a viscosity of 6000 mPa·s, a weight average molecular weight of 2000 and a hydroxyl equivalent (OHV) of 110 mg KOH/g and 14.6 g (0.0941 mol) of 2-isocyanatoethyl methacrylate were put in a reaction vessel and allowed to stand at 50° C. in a hot water bath in a nitrogen gas stream. Thereafter, 0.028 g (0.19 wt % based on the weight of 2-isocyanatoethyl methacrylate) of dibutyl tin laurate (catalyst) was added to the resulting mixture, and a reaction was allowed to proceed for 8 hours. Then, it was confirmed that the absorbance at 2260 cm⁻¹ (characteristic absorption band attributable to the isocyanate group) in the infrared absorption spectrum (FT-IR) of the reaction product (measured by FT-IR Model 200 available from Thermo Electron Co., Ltd.) was zero. This indicates that an acryl polymer having a methacryloyl group at its side chain (having a weight average molecular weight of 2100) was prepared.

Then, 8 g of the acryl polymer thus prepared as having the methacryloyl group at its side chain, 2 g of 2-hydroxyethyl acrylate (diluent), 0.5 g of 3-acryloxypropyltrimethoxysilane and 0.3 g of 2,2-dimethoxy-l,2-diphenylethan-1-one (photoradical polymerization initiator as photopolymerization initiator) were prepared, and mixed together by means of a planetary defoaming stirrer in a light shielded state. Thus, an intended UV-curable optical resin adhesive composition was prepared.

### Example 2

First, 40 g (0.0143 mol OH group) of a liquid acryl polymer (hydroxyl-containing vinyl polymer) having a viscosity of 14000 mPa·s, a weight average molecular weight of 11000 and a hydroxyl equivalent (OHV) of 20 mg KOH/g and 2.65 g (0.0171 mol) of 2-isocyanatoethyl methacrylate were put in a reaction vessel and allowed to stand at 50° C. in a hot water bath in a nitrogen gas stream. Thereafter, 0.006 g (0.23 wt % based on the weight of 2-isocyanatoethyl methacrylate) of dibutyl tin laurate (catalyst) was added to the resulting mixture, and a reaction was allowed to proceed for 8 hours. Then, it was confirmed that the absorbance at 2260 cm⁻¹ (characteristic absorption band attributable to the isocyanate group) in the infrared absorption spectrum (FT-IR) of the reaction product (measured by FT-1R Model 200 available from Thermo Electron Co., Ltd.) was zero. This indicates that an acryl polymer having a methacryloyl group at its side chain (having a weight average molecular weight of 12000) was prepared.

Then, an intended UV-curable optical resin adhesive composition was prepared in substantially the same manner as in Example 1, except that 8 g of the acryl polymer thus prepared as having the methacryloyl group at its side chain was used.

### Example 3

An intended UV-curable optical resin adhesive composition was prepared in substantially the same manner as in Example 1, except that 9.5 g of the same acryl polymer having the methacryloyl group at its side chain as prepared in Example 2, 0.5 g of tetrahydrofurfuryl acrylate (diluent), 0.21 g of 1-hydroxycyclohexyl phenyl ketone (photoradical polymerization initiator) and 0.9 g of bis(2,4,6-trimethylbenzoyl)phenylphosphine oxide were used.

### Example 4

First, 40 g (0.0784 mol OH group) of a liquid acryl polymer (hydroxyl-containing vinyl polymer) having a viscosity of 6000 mPa·s, a weight average molecular weight of 2000 and a hydroxyl equivalent (OHV) of 110 mg KOH/g and 10.9 g (0.0703 mol) of 2-isocyanatoethyl methacrylate were put in a reaction vessel and, as in Example 1, allowed to stand at 50° C. in a hot water bath in a nitrogen gas stream. Thereafter, 0.022 g (0.20 wt % based on the weight of 2-isocyanatoethyl methacrylate) of dibutyl tin laurate (catalyst) was added to the resulting mixture, and a reaction was allowed to proceed for 8 hours. Then, it was confirmed that the absorbance at 2260 cm (characteristic absorption band attributable to the isocyanate group) in the infrared absorption spectrum (FT-IR) of the reaction product (measured by FT-IR Model 200 available from Thermo Electron Co., Ltd.) was zero. This indicates that an acryl polymer having a methacryloyl group and a hydroxyl group at its side chain (having a weight average molecular weight of 2090) was prepared.

Then, 8 g of the acryl polymer thus prepared as having the methacryloyl group and the hydroxyl group at its side chain, 2 g of 2-hydroxyethyl acrylate (diluent), 0.5 g of 3-acryloxypropyltrimethoxysilane and 0.3 g of 2,2-dimethoxy-1,2-diphenylethan-1-one (photoradical polymerization initiator as photopolymerization initiator) were prepared, and mixed together by means of a planetary defoaming stirrer in a light shielded state. Thus, an intended UV-curable optical resin adhesive composition was prepared.

### Example 5

An acryl polymer (having a weight average molecular weight of 2010) having a methacryloyl group and a hydroxyl group at its side chain was prepared in substantially the same manner as in Example 4, except that 2-isocyanatoethyl methacrylate was used in an amount of 1.22 g (0.0079 mol). Then, an intended UV-curable optical resin adhesive composition was prepared in substantially the same manner as in Example 4 by employing the acryl polymer thus prepared.

### Example 6

First, 40 g (0.0143 mol OH group) of a liquid acryl polymer (hydroxyl-containing vinyl polymer) having a viscosity of 14000 mPa·s, a weight average molecular weight of 11000 and a hydroxyl equivalent (OHV) of 20 mg KOH/g and 1.08 g (0.0071 mol) of 2-isocyanatoethyl methacrylate were put in a reaction vessel and allowed to stand at 50° C. in a hot water bath in a nitrogen gas stream. Thereafter, 0.006 g (0.23 wt % based on the weight of 2-isocyanatoethyl methacrylate) of dibutyl tin laurate (catalyst) was added to the resulting mixture, and a reaction was allowed to proceed for 8 hours. Then, it was confirmed that the absorbance at 2260 cm⁻¹ (characteristic absorption band attributable to the isocyanate group) in the infrared absorption spectrum (FT-IR) of the reaction product (measured by FT-IR Model 200 available from Thermo Electron Co., Ltd.) was zero. This indicates that an acryl polymer having a methacryloyl group and a hydroxyl group at its side chain (having a weight average molecular weight of 12000) was prepared.

Then, 8 g of the acryl polymer thus prepared as having the methacryloyl group and the hydroxyl group at its side chain, 2 g of tetrahydrofurfuryl acrylate (diluent), 0.5 g of 3-acryloxypropyltrimethoxysilane, 0.21 g of 1-hydroxycyclohexyl phenyl ketone (photoradical polymerization initiator as photopolymerization initiator) and 0.09 g of bis(2,4,6-trimethylbenzoyl)phenylphosphine oxide were prepared, and mixedtogetherby meansofaplanetary defoaming stirrer in a light shielded state. Thus, an intended UV-curable optical resin adhesive composition was prepared.

### Example 7

An acryl polymer (having a weight average molecular weight of 2010) having a methacryloyl group and a hydroxyl group at its side chain was prepared in substantially the same manner as in Example 6, except that 2-isocyanatoethyl methacrylate was used in an amount of 0.44 g (0.0029 mol). Then, an intended UV-curable optical resin adhesive composition was prepared in substantially the same manner as in Example 6 by employing the acryl polymer thus prepared.

### Comparative Example 1

An intended UV-curable optical resin adhesive composition was prepared in substantially the same manner as in Example 1, except that a modified polybutadiene liquid rubber (having an average molecular weight of 3000 and a viscosity of 50 Pa·s) having a polybutadiene main chain and acrylate polymerizable functional groups at its opposite terminals was used instead of the acryl polymer having the methacryloyl group at its side chain.

### Comparative Example 2

An intended UV-curable optical resin adhesive composition was prepared in substantially the same manner as in Example 1, except that a polyurethane acrylate (having a molecular weight of not less than 10000 and a viscosity of less than 600 Pa·s) having acrylate polymerizable functional groups at its opposite terminals was used instead of the acryl polymer having the methacryloyl group at its side chain.

Characteristic property tests were performed in the following manner to evaluate the UV-curable optical resin adhesive compositions of the inventive examples and the comparative examples thus prepared. The results are shown below in Tables 1 and 2.

### Total Light Transmittance

A gap defined between two 1-mm thick slide glass plates spaced from each other via 100-μm thick spacers was filled with the UV-curable optical resin adhesive composition, which was in turn cured by irradiation with radiation emitted from a mercury lamp (10 mW/cm²) through the slide glass plates for 5 minutes (at a cumulative dose of 3000 mJ/cm²) in a nitrogen gas stream. Thus, a measurement test sample was prepared. The total light transmittance of the double-sided slide glass plate sample was measured by means of a haze meter NHM-2000 available from Nippon Denshoku Industries Co., Ltd.

### Haze

The haze of the measurement test sample was measured by means of the haze meter NHM-2000 available from Nippon Denshoku Industries Co., Ltd.

### Refractive Index

The refractive index of the measurement test sample was measured by means of Abbe refractometer NAR available from Atago Co., Ltd.

### Curing Shrinkage

The UV-curable optical resin adhesive composition was poured in an uncured state up to a gauge line in a measuring cylinder and weighed, whereby the specific gravity SG_{L} of the UV-curable optical resin adhesive composition in the uncured liquid state was determined. On the other hand, the UV-curable optical resin adhesive composition was irradiated with ultraviolet radiation at a cumulative dose of 3000 mJ/cm² to be cured, whereby a test sample (cured product) was prepared. The cured product was weighed in water, whereby the specific gravity SG_{C} of the cured product was determined. The curing shrinkage was determined from the following expression based on the measurement values. Curing shrinkage (%)=[(SG_{C}−SG_{L})/SG_{C}]×100

### Wire Cutting Strength

A space defined between two 1-mm thick slide glass plates spaced from each other via 650-μm thick spacers was filled with the UV-curable optical resin adhesive composition in an uncured state so that the adhesive composition spread to a diameter of 5 to 10 mm in the space. Then, the UV-curable optical resin adhesive composition was cured by irradiation with radiation emitted from an ultrahigh pressure mercury lamp (10 mW/cm²) at a cumulative dose of 100 mJ/cm² through the slide glass plates in a nitrogen gas stream. Thus, a measurement test sample including a cured resin layer formed between the slide glass plates was prepared. Then, the breaking strength of the cured resin layer of the double-sided slide glass plate sample was measured by pulling a 500-μm diameter SUS wire along a cured resin layer cutting direction by means of a push-pull gage (WPARX-T available from Shiro Sangyo KK).

### Swelling Property

A nonwoven fabric soaked with a solvent (methyl isobutyl ketone) was placed still on a resin residue on the slide glass plate of the broken slide glass plate sample at a room temperature (25° C.), and the resin residue swelling degree was evaluated on three levels based on the following criteria:

A (excellent): The resin residue was fully swelled.
B (acceptable): Not less than 10% of the overall area of the resin residue was swelled.
C (unacceptable): Less than 10% of the overall area of the resin residue was swelled, or the resin residue was not swelled at all.

### Clean-Up Property

The resin residue of the test sample fully swelled (rated as excellent) in the swelling evaluation test was wiped with a nonwoven fabric soaked with ethanol. The clean-up property was evaluated on two levels based on the following criteria:

A (excellent): No resin residue remained.
C (unacceptable): The resin residue remained.

It is noted that the clean-up test was not performed on test samples rated as acceptable or unacceptable in the swelling evaluation test.

### Adhesiveness

A gap defined between a 1-mm thick slide glass plate and a 0.7-mm thick slide glass plate (protective cover plate) spaced from each other via 100-pm thick spacers and a gap defined between the 1-mm thick slide glass plate and a 1-mm thick polymethacrylate resin plate (protective cover plate) spaced from each other via 100-μm thick spacers were filled with the UV-curable optical resin adhesive composition, which was in turn cured by irradiation with radiation emitted from a mercury lamp (10 mW/cm²) through the protective cover plate for 5 minutes (at a cumulative dose of 3000 mJ/cm²) in a nitrogen gas stream. Thus, a laminate board was prepared as a measurement test sample. The laminate board sample was observed at an initial stage of a test (before a treatment), after the sample was allowed to stand in a high-humidity constant-temperature chamber at 60° C. at 95% RH for 6 hours, and after the sample was allowed to stand in the high-humidity constant-temperature chamber (at 60° C. at 95% RH) for 1000 hours, and evaluated for adhesiveness on three levels based on the following criteria:

C (unacceptable): Delamination occurred at the initial stage.
B (acceptable): Delamination did not occur at the initial stage, but occurred within 6 hours when the test sample was allowed to stand in the 60° C./95% RH environment.
A (excellent): Delamination did not occur even after the sample was allowed to stand in the 60° C./95% RH environment for 1000 hours.

TABLE 1

| | Example | Example | Example | Example | Example |
|---|---|---|---|---|---|
| | 1 | 2 | 3 | 4 | 5 |
| Proportion of NCO with | 120 | 120 | 120 | 89.7 | 10.2 |
| respect to OH (mol %) *1 | | | | | |
| Total light transmittance | ≧99 | ≧99 | ≧99 | ≧99 | ≧99 |
| (%) *2 | | | | | |
| Haze (%) | 0.05 | 0.08 | 0.03 | 0.17 | 0.11 |
| Refractive index | 1.47 | 1.47 | 1.47 | 1.47 | 1.47 |
| Curing shrinkage (%) | ≦0.5 | ≦0.5 | ≦0.5 | ≦0.5 | ≦0.5 |
| Wire cutting strength (N) | 14.8 | 9.5 | 16.2 | 10.2 | 4.2 |

Swelling property

| Solvent | Methyl isobutyl ketone (MIBK) | | | | |
|---|---|---|---|---|---|
| Stand-still period (min) | 10 | 10 | 10 | 10 | 10 |
| Evaluation | A | A | A | A | A |
| Clean-up property | A | A | A | A | A |

Adhesiveness

| | | | | | |
|---|---|---|---|---|---|
| Protective Cover Plate | A | A | A | A | A |
| (slide glass plate) | | | | | |
| Protective cover plate | B | B | B | B | A |
| (polymethacrylate | | | | | |
| resin plate) | | | | | |

*1: Proportion of NCO groups of (meth) acryloyl-containing isocyanate compound with respect to OH groups of hydroxyl-containing vinyl polymer.
*2: Value with light transmittance of slide glass plates excluded.

TABLE 2

| | Example | Example | Comparative | Comparative |
|---|---|---|---|---|
| | 6 | 7 | Example 1 | Example 2 |
| Proportion of NCO with | 49.6 | 20.30 | — | — |
| respect to OH (mol %) *1 | | | | |
| Total light transmittance | ≧99 | ≧99 | ≧99 | ≧99 |
| (%) *2 | | | | |
| Haze (%) | 0.04 | 0.07 | 0.03 | 0.05 |
| Refractive index | 1.48 | 1.48 | 1.49 | 1.51 |
| Curing shrinkage (%) | ≦0.5 | ≦0.5 | 1.2 | 1.5 |
| Wire cutting strength (N) | 5.9 | 5.5 | 23.2 | 13.3 |

Swelling property

| Solvent | Methyl isobutyl ketone (MIBK) | | | |
|---|---|---|---|---|
| Stand-still period (min) | 10 | 10 | 60 | 60 |
| Evaluation | A | A | C | C |
| Clean-up property | A | A | Not | Not |
| | | | evaluated | evaluated |

Adhesiveness

| | | | | |
|---|---|---|---|---|
| Protective Cover Plate | A | A | A | A |
| (slide glass plate) | | | | |
| Protective cover plate | A | A | C | C |
| (polymethacrylate | | | | |
| resin plate) | | | | |

*1: Proportion of NCO groups of (meth)acryloyl-containing isocyanate compound with respect to OH groups of hydroxyl-containing vinyl polymer.
*2: Value with light transmittance of slide glass plates excluded.

The above results indicate that the products of the inventive examples each had a higher light transmittance and a lower curing shrinkage, and was highly swellable to the solvent and excellent in clean-up property. Therefore, the products of the inventive examples were excellent in transparency and durability, and were apparently suitable for rework (repair). Further, the products of the inventive examples were excellent in adhesiveness to the slide glass plate and the polymethacrylate resin plate.

In contrast, the products of the comparative examples were excellent in transparency with a higher light transmittance. However, the products of the comparative examples each had a higher curing shrinkage, and were poorer in clean-up property with a lower swellability to the solvent even after being kept in contact with the solvent for a longer period of time on the order of 60 minutes. Thus, the products of the comparative examples were apparently unsuitable for rework (repair), though having no problem in transparency. In addition, the products of the comparative examples were excellent in adhesiveness to the slide glass plate like the products of the inventive examples, but were poorer in adhesiveness to the polymethacrylate resin plate because the delamination occurred at the initial stage.

As described above, the UV-curable optical resin adhesive composition is useful as an optical filling resin material for filling a gap between a liquid crystal display panel and a protective cover plate in a liquid crystal display device.

Although a specific form of embodiment of the instant invention has been described above in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. A UV-curable optical resin adhesive composition for filling a gap between an image display panel and a protective cover plate, the UV-curable optical resin adhesive composition comprising:
(A) an acryl polymer having a (meth)acryloyl group at its side chain; and
(B) a photopolymerization initiator.

2. The UV-curable optical resin adhesive composition according to claim 1, wherein the acryl polymer (A) is an acryl polymer having a (meth)acryloyl group and a hydroxyl group at its side chain.

3. The UV-curable optical resin adhesive composition according to claim 1, wherein the acryl polymer (A) has a weight average molecular weight of 1000 to 20000.

4. The UV-curable optical resin adhesive composition according to claim 2, wherein the acryl polymer (A) has a weight average molecular weight of 1000 to 20000.

5. The UV-curable optical resin adhesive composition according to claim 1, further comprising a monofunctional (meth)acrylate compound as a reactive diluent.

6. The UV-curable optical resin adhesive composition according to claim 2, further comprising a monofunctional (meth)acrylate compound as a reactive diluent.

7. The UV-curable optical resin adhesive composition according to claim 3, further comprising a monofunctional (meth)acrylate compound as a reactive diluent.

8. The UV-curable optical resin adhesive composition according to claim 4, further comprising a monofunctional (meth)acrylate compound as a reactive diluent.
